(19) United States
(12) Patent Application Publication
(10) Pub. No.: US 2020/0037022 A1
(43) Pub. Date: Jan. 30, 2020

(54) AUDIO PROCESSING FOR EXTRACTION OF VARIABLE LENGTH DISJOINT SEGMENTS FROM AUDIOVISUAL CONTENT

(71) Applicant: Thuuz, Inc., Palo Alto, CA (US)

(72) Inventors: Mihailo Stojancic, San Jose, CA (US); Warren Packard, Palo Alto, CA (US)

(21) Appl. No.: 16/440,229

(22) Filed: Jun. 13, 2019

Related U.S. Application Data
(60) Provisional application No. 62/712,041, filed on Jul. 30, 2018.
(60) Provisional application No. 62/746,454, filed on Oct. 16, 2018.

(51) Int. Cl. H04N 21/439; G06F 3/16; G10L 25/03

(52) U.S. Cl. CPC H04N 21/4394; G10L 25/03; G06F 3/165

(57) ABSTRACT

A boundary of a highlight of audiovisual content depicting an event is identified. The audiovisual content may be a broadcast, such as a television broadcast of a sporting event. The highlight may be a segment of the audiovisual content deemed to be of particular interest. Audio data for the audiovisual content is stored, and the audio data is automatically analyzed to detect soft-entry points identified as low spectral activity points and/or low volume points in the analyzed audio data. A time index within the audiovisual content, corresponding to the soft-entry point, may be designated as the boundary, which may be the beginning or end of the highlight.

### CROSS-REFERENCE TO RELATED APPLICATIONS

The present application claims the benefit of U.S. Provisional Application Ser. No. 62/712,041 for “Audio Processing for Extraction of Variable Length Disjoint Segments from Television Signal” (Attorney Docket No. THU006-PROV), filed Jul. 30, 2018, which is incorporated herein by reference in its entirety.

The present application claims the benefit of U.S. Provisional Application Ser. No. 62/746,454 for “Audio Processing for Detecting Occurrences of Loud Sound Characterized by Short-Time Energy Bursts” (Attorney Docket No. THU016-PROV), filed Oct. 16, 2018, which is incorporated herein by reference in its entirety.

The present application is related to U.S. Utility application Ser. No. 13/601,915 for “Generating Excitement Levels for Live Performances,” filed Aug. 31, 2012 and issued on Jun. 16, 2015 as U.S. Pat. No. 9,060,210, which is incorporated herein by reference in its entirety.

The present application is related to U.S. Utility application Ser. No. 13/601,927 for “Generating Alerts for Live Performances,” filed Aug. 31, 2012 and issued on Sep. 23, 2014 as U.S. Pat. No. 8,842,007, which is incorporated herein by reference in its entirety.

The present application is related to U.S. Utility application Ser. No. 13/601,933 for “Generating Teasers for Live Performances,” filed Aug. 31, 2012 and issued on Nov. 26, 2013 as U.S. Pat. No. 8,595,763, which is incorporated herein by reference in its entirety.

The present application is related to U.S. Utility application Ser. No. 14/510,481 for “Generating a Customized Highlight Sequence Depicting an Event” (Attorney Docket No. THU001), filed Oct. 9, 2014, which is incorporated herein by reference in its entirety.

The present application is related to U.S. Utility application Ser. No. 14/710,438 for “Generating a Customized Highlight Sequence Depicting Multiple Events” (Attorney Docket No. THU002), filed May 12, 2015, which is incorporated herein by reference in its entirety.

The present application is related to U.S. Utility application Ser. No. 14/877,691 for “Customized Generation of Highlight Show with Narrative Component” (Attorney Docket No. THU004), filed Oct. 7, 2015, which is incorporated herein by reference in its entirety.

The present application is related to U.S. Utility application Ser. No. 15/264,928 for “User Interface for Interaction with Customized Highlight Shows” (Attorney Docket No. THU005), filed Sep. 14, 2016, which is incorporated herein by reference in its entirety.

The present application is related to U.S. Utility application Ser. No. 16/411,704 for “Video Processing for Enabling Sports Highlights Generation” (Attorney Docket No. THU009), filed May 14, 2019 which is incorporated herein by reference in its entirety.

The present application is related to U.S. Utility application Ser. No. 16/411,710 for “Machine Learning for Recognizing and Interpreting Embedded Information Card Content” (Attorney Docket No. THU010), filed May 14, 2019, which is incorporated herein by reference in its entirety.

The present application is related to U.S. Utility application Ser. No. 16/411,713 for “Video Processing for Embedded Information Card Localization and Content Extraction” (Attorney Docket No. THU012), filed May 14, 2019, which is incorporated herein by reference in its entirety.

The present application is related to U.S. Utility application Ser. No. 16/421,391 for “Audio Processing for Detecting Occurrences of Crowd Noise in Sporting Event Television Programming” (Attorney Docket No. THU007), filed May 23, 2019, which is incorporated herein by reference in its entirety.

### TECHNICAL FIELD

The present document relates to techniques for identifying multimedia content and associated information on a television device or a video server delivering multimedia content, and enabling embedded software applications to utilize the multimedia content to provide content and services synchronously with delivery of the multimedia content. Various embodiments relate to methods and systems for providing automated audio analysis to segment programming content depicting sporting events, so as to create video highlights for in-game and post-game viewing.

### DESCRIPTION OF THE RELATED ART

Enhanced television applications such as interactive advertising and enhanced program guides with pre-game, in-game and post-game interactive applications have long been envisioned. Existing cable systems that were originally engineered for broadcast television are being called on to support a host of new applications and services including interactive television services and enhanced (interactive) programming guides.

Some frameworks for enabling enhanced television applications have been standardized. Examples include the OpenCable™ Enhanced TV Application Messaging Specification, as well as the Tru2way specification, which refer to interactive digital cable services delivered over a cable video network and which include features such as interactive program guides, interactive ads, games, and the like. Additionally, cable operator “OCAP” programs provide interactive services such as e-commerce shopping, online banking, electronic program guides, and digital video recording. These efforts have enabled the first generation of video-synchronous applications, synchronized with video content delivered by the programmer/broadcaster, and providing added data and interactivity to television programming.

Recent developments in video/audio content analysis technologies and capable mobile devices have opened up an array of new possibilities in developing sophisticated applications that operate synchronously with live TV programming events. These new technologies and advances in audio signal processing and computer vision, as well as improved computing power of modern processors, allow for real-time generation of sophisticated programming content highlights accompanied by metadata that are currently lacking in the television and other media environments.

### SUMMARY

A system and method are presented to enable automatic real-time segmentation of sports event television programming and/or other audiovisual content, based on audio processing for detecting low spectral activity and/or low volume entry points in the audio stream such as ends of syllables, ends of words or groups of words, and/or ends of sentences (soft-entry points). A list of detected soft-entry points (with minimal spectral activity and/or low volume) may be used to extract segments of the audiovisual content according to criteria for video highlight generation.

In at least one embodiment, a spectrogram is constructed for the audio signal, allowing for time-frequency analysis with a sliding 2-D area window. For each analysis window position, a spectral qualifier may be generated, representing spectral activity within the analysis window. A vector of spectral qualifiers with associated time positions may be formed, and the vector may be further partitioned into a set of contiguous one-second intervals. For each one-second interval, internal qualifiers may be sorted, and non-maximum suppression may be performed to form a first vector of qualifier/position pairs with the maximized qualifier for each one-second interval. In subsequent steps, detected entry points in one-second intervals may be processed to provide for desired average time spacing and/or for further selection of qualifier/position pairs.

After an initial anchor element is established in a first vector of qualifier/position pairs (the first element), the next element of the first vector of qualifier/position pairs may be selected at a minimum desired distance (such as, for example, two seconds). Next, the immediate left and right neighborhood of the next element may be examined to generate a new anchor element with a maximized qualifier for the local neighborhood. This process may continue until all elements of the first vector of the qualifier/position pairs are exhausted, thus producing a new set of entry points (soft entries) with variable mutual distances averaging two to three seconds, and with a maximized spectral qualifier for each local neighborhood.

The vector of soft entries may then be translated to a list of best entry points, and subsequently applied to video highlight generation. Highlighted video segment boundaries may be revised according to the best available soft entries in the neighborhood of their original boundaries, and the highlights may subsequently be extracted for further processing by a video highlight generation application.

In at least one embodiment, extracted video highlight segments may also be processed by deploying an optional fading function with mirrored lead and trail curvatures applied to segment boundaries, allowing for further smoothing of transitions between extracted disjoint video segments.

The method presented herein can be generalized, in the sense that it can be used for video segmentation in any application requiring smooth reassembly of segmented video with minimally obtrusive audio transitions.

In at least one embodiment, a method for identifying a boundary of a highlight of audiovisual content depicting an event may include storing audio data depicting at least part of the event, automatically analyzing the audio data to detect a soft-entry point of the audio data, and designating a time index, within the audiovisual content, corresponding to the soft-entry point as the boundary, the boundary comprising a beginning or an end of the highlight. The audiovisual content may be, for example, a television broadcast of a sporting event.

The audiovisual content may include an audiovisual stream. The method may further include, prior to storing audio data depicting at least part of the event, extracting the audio data from the audiovisual stream.

The audiovisual content may include stored audiovisual content and/or real-time content. The method may further include, prior to storing audio data depicting at least part of the event, extracting the audio data from the stored audiovisual content and/or the real-time content.

The event may be a sporting event. The highlight may depict a portion of the sporting event deemed to be of particular interest to one or more users.

The method may further include playing one of the audiovisual content and the highlight at an output device, during detection of the soft-entry point.

The method may further include, prior to detecting the soft-entry point, pre-processing the audio data by resampling the audio data to a desired sampling rate.

The method may further include, prior to detecting the soft-entry point, pre-processing the audio data by filtering the audio data to reduce or remove noise.

The method may further include, prior to detecting the soft-entry point, processing the audio data to generate a spectrogram for at least part of the audio data.

Detecting the soft-entry point may include applying a sliding two-dimensional time-frequency analysis window for the spectrogram.

Detecting the soft-entry point may include computing an average spectral magnitude indicator for each position of a sliding two-dimensional time-frequency analysis window of the spectrogram and using the average spectral magnitude indicators to form a vector of spectral magnitude indicator/position pairs for the spectrogram.

Detecting the soft-entry point may further include converting the average spectral magnitude indicator for each vector element into an integer qualifier Q and generating an initial vector with Q/position pairs.

Detecting the soft-entry point may further include stepping through the elements of the initial vector with Q/position pairs, and maximizing Q per each one-second interval by performing non-maximum suppression of Q qualifiers in each one-second interval, and forming a first vector with maximized Q qualifiers.

Detecting the soft-entry point may further include stepping through a time component of each entry of the first vector with a maximized Q qualifier; for each time position, comparing a time component of a current position with a previous time component of a previous position to obtain a distance; for each element of the first vector for which the distance is greater than a threshold, finding a largest Q in an immediate neighborhood of that element position; and populating a new soft-entry vector with Q/position pairs with the largest Q in each neighborhood.

The method may further include, prior to designating the time index as the boundary, identifying the highlight with a tentative boundary. Designating the time index as the boundary may include replacing the tentative boundary with the boundary obtained from the list of available soft-entries.

Further details and variations are described herein.

### BRIEF DESCRIPTION OF THE DRAWINGS

The accompanying drawings, together with the description, illustrate several embodiments. One skilled in the art will recognize that the particular embodiments illustrated in the drawings are merely exemplary, and are not intended to limit scope.

FIG. 1A is a block diagram depicting a hardware architecture according to a client/server embodiment, wherein event content is provided via a network-connected content provider.

FIG. 1B is a block diagram depicting a hardware architecture according to another client/server embodiment, wherein event content is stored at a client-based storage device.

FIG. 1C is a block diagram depicting a hardware architecture according to a standalone embodiment.

FIG. 1D is a block diagram depicting an overview of a system architecture, according to one embodiment.

FIG. 2 is a schematic block diagram depicting examples of data structures that may be incorporated into the audio data, user data, and highlight data of FIGS. 1A, B, and 1C, according to one embodiment.

FIG. 3A depicts an example of an audio waveform graph showing occurrences of soft-entry points in an audio stream extracted from sporting event television programming content in a time domain, according to one embodiment.

FIG. 3B depicts an example of a spectrogram corresponding to the audio waveform graph of FIG. 3A, in a time-frequency domain, according to one embodiment.

FIG. 4 is a flowchart depicting a method for audio pre-processing by resampling, filtering and spectrogram construction, according to one embodiment.

FIG. 5 is a flowchart depicting a method for analyzing audio data, such as audio stream, in the time-frequency domain, and generating an initial vector of qualifiers, according to one embodiment.

FIG. 6 is a flowchart depicting a method for generating a vector with maximized qualifiers within each one-second interval, according to one embodiment.

FIG. 7 is a flowchart depicting a method for further selection of soft-entry points with variable spacing and maximized local neighborhood qualifier, according to one embodiment.

FIG. 8 is a flowchart depicting a method for optional revision of detected entry points for sparse segmentation, according to one embodiment.

FIG. 9 is a flowchart depicting a method for assembling adjusted highlights based on a list of available soft-entry points, according to one embodiment.

### DETAILED DESCRIPTION

### Definitions

The following definitions are presented for explanatory purposes only, and are not intended to limit scope.
Event: For purposes of the discussion herein, the term “event” refers to a game, session, match, series, performance, program, concert, and/or the like, or portion thereof (such as an act, period, quarter, half, inning, scene, chapter, or the like). An event may be a sporting event, entertainment event, a specific performance of a single individual or subset of individuals within a larger population of participants in an event, or the like. Examples of non-sporting events include television shows, breaking news, socio-political incidents, natural disasters, movies, plays, radio shows, podcasts, audiobooks, online content, musical performances, and/or the like. An event can be of any length. For illustrative purposes, the technology is often described herein in terms of sporting events; however, one skilled in the art will recognize that the technology can be used in other contexts as well, including highlight shows for any audiovisual, audio, visual, graphics-based, interactive, non-interactive, or text-based content. Thus, the use of the term “sporting event” and any other sports-specific terminology in the description is intended to be illustrative of one possible embodiment, but is not intended to restrict the scope of the described technology to that one embodiment. Rather, such terminology should be considered to extend to any suitable non-sporting context as appropriate to the technology. For ease of description, the term “event” is also used to refer to an account or representation of an event, such as an audiovisual recording of an event, or any other content item that includes an accounting, description, or depiction of an event.
Highlight: An excerpt or portion of an event, or of content associated with an event that is deemed to be of particular interest to one or more users. A highlight can be of any length. In general, the techniques described herein provide mechanisms for identifying and presenting a set of customized highlights (which may be selected based on particular characteristics and/or preferences of the user) for any suitable event. “Highlight” can also be used to refer to an account or representation of a highlight, such as an audiovisual recording of a highlight, or any other content item that includes an accounting, description, or depiction of a highlight. Highlights need not be limited to depictions of events themselves, but can include other content associated with an event. For example, for a sporting event, highlights can include in-game audio/video, as well as other content such as pre-game, in-game, and post-game interviews, analysis, commentary, and/or the like. Such content can be recorded from linear television (for example, as part of the audiovisual stream depicting the event itself), or retrieved from any number of other sources. Different types of highlights can be provided, including for example, occurrences (plays), strings, possessions, and sequences, all of which are defined below. Highlights need not be of fixed duration, but may incorporate a start offset and/or end offset, as described below.
Clip: A portion of an audio, visual, or audiovisual representation of an event. A clip may correspond to or represent a highlight. In many contexts herein, the term “segment” is used interchangeably with “clip”. A clip may be a portion of an audio stream, video stream, or audiovisual stream, or it may be a portion of stored audio, video, or audiovisual content.
Content Delineator: One or more video frames that indicate the start or end of a highlight.
Occurrence: Something that takes place during an event. Examples include: a goal, a play, a down, a hit, a save, a shot on goal, a basket, a steal, a snap or attempted snap, a near-miss, a fight, a beginning or end of a game, quarter, half, period, or inning, a pitch, a penalty, an injury, a dramatic incident in an entertainment event, a song, a solo, and/or the like. Occurrences can also be unusual, such as a power outage, an incident with an unruly fan, and/or the like. Detection of such occurrences can be used as a basis for determining whether or not to designate a particular portion of an audiovisual stream as a highlight. Occurrences are also referred to herein as “plays”, for ease of nomenclature, although such usage should not be construed to limit scope. Occurrences may be of any length, and the representation of an occurrence may be of varying length. For example, as mentioned above, an extended representation of an occurrence may include footage depicting the period of time just before and just after the occurrence, while a brief representation may include just the occurrence itself. Any intermediate representation can also be provided. In at least one embodiment, the selection of a duration for a representation of an occurrence can depend on user preferences, available time, determined level of excitement for the occurrence, importance of the occurrence, and/or any other factors.
Offset: The amount by which a highlight length is adjusted. In at least one embodiment, a start offset and/or end offset can be provided, for adjusting start and/or end times of the highlight, respectively. For example, if a highlight depicts a goal, the highlight may be extended (via an end offset) for a few seconds so as to include celebrations and/or fan reactions following the goal. Offsets can be configured to vary automatically or manually, based for example on an amount of time available for the highlight, importance and/or excitement level of the highlight, and/or any other suitable factors.
String: A series of occurrences that are somehow linked or related to one another. The occurrences may take place within a possession (defined below), or may span multiple possessions. The occurrences may take place within a sequence (defined below), or may span multiple sequences. The occurrences can be linked or related because of some thematic or narrative connection to one another, or because one leads to another, or for any other reason. One example of a string is a set of passes that lead to a goal or basket. This is not to be confused with a “text string,” which has the meaning ordinarily ascribed to it in the computer programming arts.
Possession: Any time-delimited portion of an event. Demarcation of start/end times of a possession can depend on the type of event. For certain sporting events wherein one team may be on the offensive while the other team is on the defensive (such as basketball or football, for example), a possession can be defined as a time period while one of the teams has the ball. In sports such as hockey or soccer, where puck or ball possession is more fluid, a possession can be considered to extend to a period of time wherein one of the teams has substantial control of the puck or ball, ignoring momentary contact by the other team (such as blocked shots or saves). For baseball, a possession is defined as a half-inning. For football, a possession can include a number of sequences in which the same team has the ball. For other types of sporting events as well as for non-sporting events, the term “possession” may be somewhat of a misnomer, but is still used herein for illustrative purposes. Examples in a non-sporting context may include a chapter, scene, act, or the like. For example, in the context of a music concert, a possession may equate to performance of a single song. A possession can include any number of occurrences.
Sequence: A time-delimited portion of an event that includes one continuous time period of action. For example, in a sporting event, a sequence may begin when action begins (such as a face-off, tipoff, or the like), and may end when the whistle is blown to signify a break in the action. In a sport such as baseball or football, a sequence may be equivalent to a play, which is a form of occurrence. A sequence can include any number of possessions, or may be a portion of a possession.
Highlight show: A set of highlights that are arranged for presentation to a user. The highlight show may be presented linearly (such as an audiovisual stream), or in a manner that allows the user to select which highlight to view and in which order (for example by clicking on links or thumbnails). Presentation of highlight show can be non-interactive or interactive, for example allowing a user to pause, rewind, skip, fast-forward, communicate a preference for or against, and/or the like. A highlight show can be, for example, a condensed game. A highlight show can include any number of contiguous or noncontiguous highlights, from a single event or from multiple events, and can even include highlights from different types of events (e.g. different sports, and/or a combination of highlights from sporting and non-sporting events).
User/viewer: The terms “user” or “viewer” interchangeably refer to an individual, group, or other entity that is watching, listening to, or otherwise experiencing an event, one or more highlights of an event, or a highlight show. The terms “user” or “viewer” can also refer to an individual, group, or other entity that may at some future time watch, listen to, or otherwise experience either an event, one or more highlights of an event, or a highlight show. The term “viewer” may be used for descriptive purposes, although the event need not have a visual component, so that the “viewer” may instead be a listener or any other consumer of content.
Excitement level: A measure of how exciting or interesting an event or highlight is expected to be for a particular user or for users in general. Excitement levels can also be determined with respect to a particular occurrence or player. Various techniques for measuring or assessing excitement level are discussed in the above-referenced related applications. As discussed, excitement level can depend on occurrences within the event, as well as other factors such as overall context or importance of the event (playoff game, pennant implications, rivalries, and/or the like). In at least one embodiment, an excitement level can be associated with each occurrence, string, possession, or sequence within an event. For example, an excitement level for a possession can be determined based on occurrences that take place within that possession. Excitement level may be measured differently for different users (e.g. a fan of one team vs. a neutral fan), and it can depend on personal characteristics of each user.
Metadata: Data pertaining to and stored in association with other data. The primary data may be media such as a sports program or highlight.
Video data. A length of video, which may be in digital or analog form. Video data may be stored at a local storage device, or may be received in real-time from a source such as a TV broadcast antenna, a cable network, or a computer server, in which case it may also be referred to as a “video stream”. Video data may or may not include an audio component; if it includes an audio component, it may be referred to as “audiovisual data” or an “audiovisual stream”.
Audio data. A length of audio, which may be in digital or analog form. Audio data may be the audio component of audiovisual data or an audiovisual stream, and may be isolated by extracting the audio data from the audiovisual data. Audio data may be stored at a local storage, or may be received in real-time from a source such as a TV broadcast antenna, a cable network, or a computer server, in which case it may also be referred to as an “audio stream”.
Stream. An audio stream, video stream, or audiovisual stream.
Time index. An indicator of a time, within audio data, video data, or audiovisual data, at which an event occurs or that otherwise pertains to a designated segment, such as a highlight.
Spectrogram. A visual representation of the spectrum of frequencies of a signal, such as an audio stream, as it varies with time. A spectrogram may be a two-dimensional time-frequency representation of audio signal derived by applying Short Time Fourier Transform (STFT) to the audio signal.
Analysis window. A designated subset of video data, audio data, audiovisual data, spectrogram, stream, or otherwise processed version of a stream or data, at which one step of analysis is to be focused. The audio data, video data, audiovisual data, or spectrogram may be analyzed, for example, in segments using a moving analysis window and/or a series of analysis windows covering different segments of the data or spectrogram.
Boundary. A demarcation separating one audio, video, and/or audiovisual segment from another. A boundary may be the beginning or end of a segment such as a highlight of audiovisual content such as a television broadcast. A boundary may be tentative (i.e., preliminary and/or intended for subsequent replacement) or final. In some embodiments, a highlight may first be identified with tentative boundaries. Audio analysis may be performed to identify soft-entry points that are then used to locate (in time) the final boundaries of the highlight.
Soft-Entry Point. A portion of an audio, video, or audiovisual stream representing a likely or favored transition point between different scenes, types of content, plays, or the like. A soft-entry point may be a quieter portion of an audio signal representing, in the context of a sporting event, a pause between commentary or plays in the game.

### Overview

In at least one embodiment, the system and method described herein perform automatic real-time, variable-length segmentation of an audiovisual program, such as a television program, based on audio processing for detecting low activity entry points (“soft-entry points”) such as the end of syllables, sentences, and/or groups of words. These entry points may be used as guides when extracting segments of an audiovisual program in order to facilitate highlight generation with improved transitions from one highlight to the next, so as to avoid cutting off dialogue or other sounds, and to avoid abrupt transitions.

In at least one embodiment, an automated video highlights and associated metadata generation application may receive a live broadcast audiovisual stream, or a digital audiovisual stream received via a computer server. The application may then process audio data, such as an audio stream extracted from the audiovisual stream, for example using digital signal processing techniques, to detect soft-entry points.

In alternative embodiments, the techniques described herein can be applied to other types of source content. For example, the audio data need not be extracted from an audiovisual stream; rather, it may be a radio broadcast or other audio depiction of a sporting event or other event. Alternatively, the techniques described herein can be applied to stored audio data depicting an event; such data may or may not be extracted from stored audiovisual data.

Interactive television applications enable timely, relevant presentation of highlighted television programming content to users watching television programming either on a primary television display, or on a secondary display such as tablet, laptop or a smartphone. In at least one embodiment, a set of clips representing television broadcast content highlights is generated and/or stored in real-time, along with a database containing time-based metadata describing, in more detail, the events presented by the highlight clips. As described in more detail herein, the start and/or end times of such clips can be determined, at least in part, based on analysis of the extracted audio data.

In various embodiments, the metadata accompanying clips can be any information such as textual information, images, and/or any type of audiovisual data. One type of metadata associated with both in-game and post-game video content highlights present events detected by real-time processing of audio data extracted from sporting event television programming or other audiovisual content. In various embodiments, the system and method described herein enable automatic metadata generation and video highlight processing, wherein the start and/or end times of highlights can be detected and/or refined by analyzing digital audio data such an audio stream.

For example, a highlight can be identified by analyzing such audio data to detect cheering crowd noise following certain exciting events, audio announcements, music, and/or the like. Additionally, or alternatively, a highlight may be detected in any of the other ways presented in any of the parent applications listed above. Identification of the soft-entry points may be used to identify or refine the start and/or end times of the highlight, so that the highlight begins and/or ends at a natural break in the audiovisual content, thus avoiding unnecessarily abrupt transitions. In at least one embodiment, real-time processing is performed on the audio data, which may be an audio stream extracted from sporting event television programming content, so as to detect, select, and track such soft-entry points.

In at least one embodiment, a method for automatic real-time processing of an audio signal extracted from audiovisual content, such as sporting event television programming content, detects soft-entry points. The method may include capturing, decoding, and pre-processing of audio signal, generating a time-frequency audio spectrogram for joined time-frequency analysis to detect areas of low spectral activity, generating spectral indicators for overlapping spectrogram areas, and forming a vector of spectral qualifiers with associated time positions. The method may further include partitioning the vector into contiguous one-second intervals, sorting internal spectral qualifiers for each one-second interval, and performing non-maximum suppression, to form a first vector of qualifier/position pairs. Further, the method may include processing the first vector of each qualifier/position pair to provide for desired average time spacing and for further selection of qualifier/position pairs. Yet further, the method may include forming a list of best entry points, and applying the list of best entry points to video highlights generation, for example, by revising highlighted video segments boundaries, according to the best available soft entries in the neighborhood of the original boundaries.

In at least one embodiment, the system and method receive compressed audio data, and read, decode, and resample the compressed audio data at a desired sampling rate. Pre-filtering may be performed for noise reduction, click removal, and selection of frequency band of interest; any of a number of interchangeable digital filtering stages can be used.

The overlapping spectrogram areas may be analyzed by a 2-D time-frequency window of sub-second time extent. In at least one embodiment, the analyzing time-frequency window is slid along the spectrogram time coordinate, and a normalized average magnitude for the window is computed at each overlapping window position.

The average magnitude may be a spectral indicator generated at each analyzing window position. An initial vector of spectral indicators with associated time positions may be formed and further partitioned into contiguous one-second intervals. For each one-second interval, internal qualifiers may be sorted, and non-maximum suppression may be performed to form a first vector of qualifier/position pairs. Detected entry points in one-second intervals may be processed to provide for desired average time spacing and for further selection of qualifier/position pairs. For illustrative purposes, the description herein refers to one-second intervals; however, one skilled in the art will recognize that intervals of any suitable length can be used.

After an initial anchor element is established (the first element), the next element may be selected at a minimum desired distance with a length such as two seconds. Other lengths can also be used. Elements in the immediate left and right neighborhood of the next element may be examined to generate a new anchor element with maximized qualifier for the local neighborhood. All first vectors of qualifier/position pairs may be processed in successive steps, producing a new set of soft-entry points with variable mutual distances averaging, for example, two to three seconds, and with a maximized spectral qualifier for each local neighborhood.

The vector of soft entries may be translated to a list of best entry points and subsequently applied to video highlights generation. Highlighted video segment boundaries may be revised according to the best available soft entries in the neighborhood of their original boundaries. Highlighted video segments with revised boundaries may be extracted for further processing by a video highlight generating application. Extracted video highlight segments may be additionally processed by deploying an optional fading function with mirrored lead and trail curvatures applied to segment boundaries.

### System Architecture

According to various embodiments, the system can be implemented on any electronic device, or set of electronic devices, equipped to receive, store, and present information. Such an electronic device may be, for example, a desktop computer, laptop computer, television, smartphone, tablet, music player, audio device, kiosk, set-top box (STB), game system, wearable device, consumer electronic device, and/or the like.

Although the system is described herein in connection with an implementation in particular types of computing devices, one skilled in the art will recognize that the techniques described herein can be implemented in other contexts, and indeed in any suitable device capable of receiving and/or processing user input, and presenting output to the user. Accordingly, the following description is intended to illustrate various embodiments by way of example, rather than to limit scope.

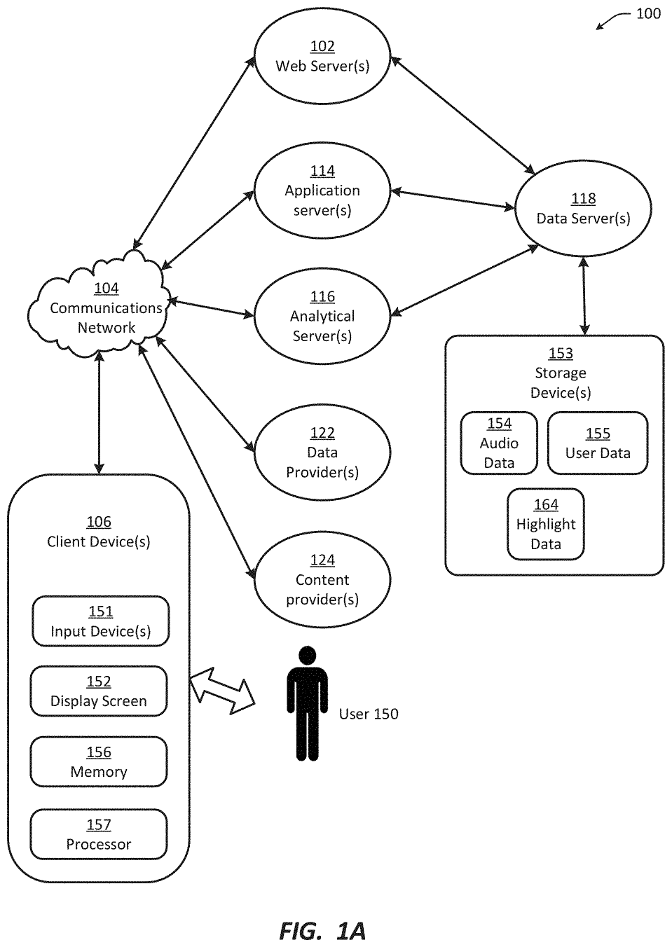

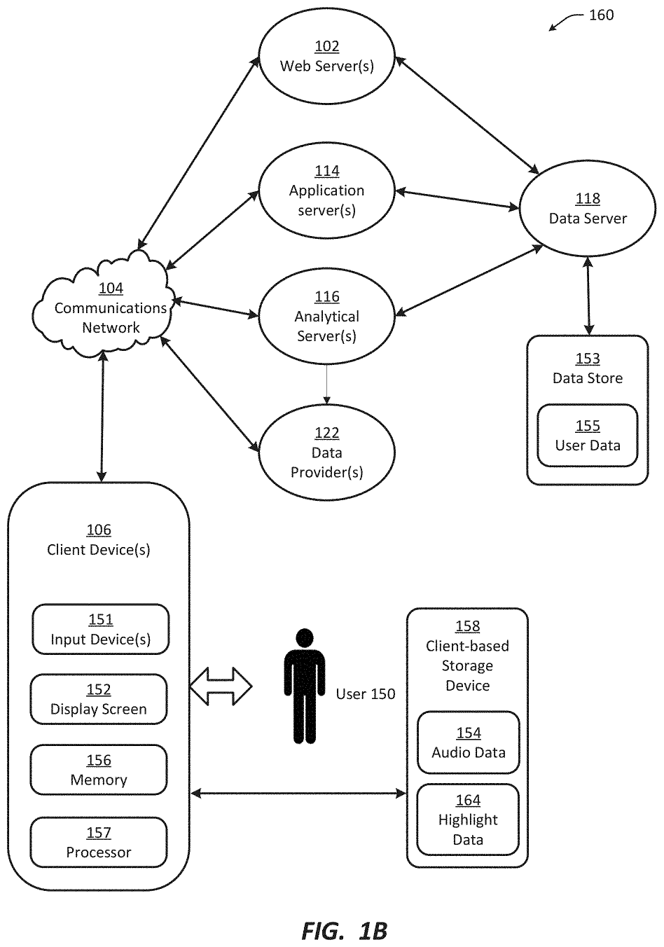

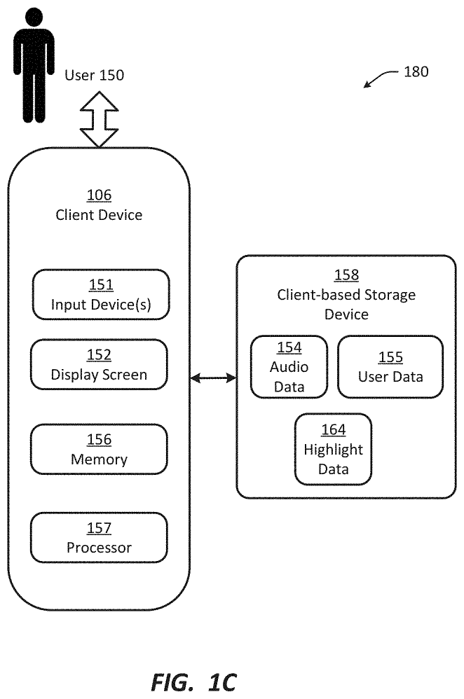

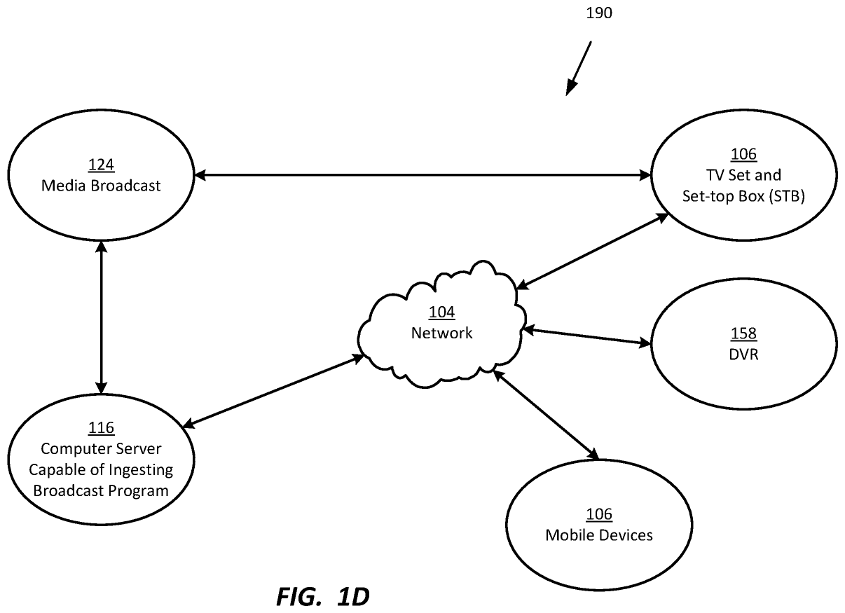

Referring now to FIG. 1A, there is shown a block diagram depicting hardware architecture of a system 100 for automatically analyzing audio data to detect a soft-entry point to designate a boundary of a highlight, according to a client/server embodiment. Event content, such as an audiovisual stream including audio content, may be provided via a network-connected content provider 124. An example of such a client/server embodiment is a web-based implementation, wherein each of one or more client devices 106 runs a browser or app that provides a user interface for interacting with content from various servers 102, 114, 116, including data provider(s) servers 122, and/or content provider(s) servers 124, via communications network 104. Transmission of content and/or data in response to requests from client device 106 can take place using any known protocols and languages, such as Hypertext Markup Language (HTML), Java, Objective C, Python, JavaScript, and/or the like.

Client device 106 can be any electronic device, such as a desktop computer, laptop computer, television, smartphone, tablet, music player, audio device, kiosk, set-top box, game system, wearable device, consumer electronic device, and/or the like. In at least one embodiment, client device 106 has a number of hardware components well known to those skilled in the art. Input device(s) 151 can be any component(s) that receive input from user 150, including, for example, a handheld remote control, keyboard, mouse, stylus, touch-sensitive screen (touchscreen), touchpad, gesture receptor, trackball, accelerometer, five-way switch, microphone, or the like. Input can be provided via any suitable mode, including for example, one or more of: pointing, tapping, typing, dragging, gesturing, tilting, shaking, and/or speech. Display screen 152 can be any component that graphically displays information, video, content, and/or the like, including depictions of events, highlights, and/or the like. Such output may also include, for example, audiovisual content, data visualizations, navigational elements, graphical elements, queries requesting information and/or parameters for selection of content, metadata, and/or the like. In at least one embodiment, where only some of the desired output is presented at a time, a dynamic control, such as a scrolling mechanism, may be available via input device(s) 151 to choose which information is currently displayed, and/or to alter the manner in which the information is displayed.

Processor 157 can be a conventional microprocessor for performing operations on data under the direction of software, according to well-known techniques. Memory 156 can be random-access memory, having a structure and architecture as are known in the art, for use by processor 157 in the course of running software for performing the operations described herein. Client device 106 can also include local storage (not shown), which may be a hard drive, flash drive, optical or magnetic storage device, web-based (cloud-based) storage, and/or the like.

Any suitable type of communications network 104, such as the Internet, a television network, a cable network, a cellular network, and/or the like can be used as the mechanism for transmitting data between client device 106 and various server(s) 102, 114, 116 and/or content provider(s) 124 and/or data provider(s) 122, according to any suitable protocols and techniques. In addition to the Internet, other examples include cellular telephone networks, EDGE, 3G, 4G, long term evolution (LTE), Session Initiation Protocol (SIP), Short Message Peer-to-Peer protocol (SMPP), SS7, Wi-Fi, Bluetooth, ZigBee, Hypertext Transfer Protocol (HTTP), Secure Hypertext Transfer Protocol (SHTTP), Transmission Control Protocol/Internet Protocol (TCP/IP), and/or the like, and/or any combination thereof. In at least one embodiment, client device 106 transmits requests for data and/or content via communications network 104, and receives responses from server(s) 102, 114, 116 containing the requested data and/or content.

In at least one embodiment, the system of FIG. 1A operates in connection with sporting events; however, the teachings herein apply to non-sporting events as well, and it is to be appreciated that the technology described herein is not limited to application to sporting events. For example, the technology described herein can be utilized to operate in connection with a television show, movie, news event, game show, political action, business show, drama, and/or other episodic content, or for more than one such event.

In at least one embodiment, system 100 identifies highlights of audiovisual content depicting an event, such as a broadcast of a sporting event, by analyzing audio content representing the event. This analysis may be carried out in real-time. In at least one embodiment, system 100 includes one or more web server(s) 102 coupled via a communications network 104 to one or more client devices 106. Communications network 104 may be a public network, a private network, or a combination of public and private networks such as the Internet. Communications network 104 can be a LAN, WAN, wired, wireless and/or combination of the above. Client device 106 is, in at least one embodiment, capable of connecting to communications network 104, either via a wired or wireless connection. In at least one embodiment, client device may also include a recording device capable of receiving and recording events, such as a DVR, PVR, or other media recording device. Such recording device can be part of client device 106, or can be external; in other embodiments, such recording device can be omitted. Although FIG. 1A shows one client device 106, system 100 can be implemented with any number of client device(s) 106 of a single type or multiple types.

Web server(s) 102 may include one or more physical computing devices and/or software that can receive requests from client device(s) 106 and respond to those requests with data, as well as send out unsolicited alerts and other messages. Web server(s) 102 may employ various strategies for fault tolerance and scalability such as load balancing, caching and clustering. In at least one embodiment, web server(s) 102 may include caching technology, as known in the art, for storing client requests and information related to events.

Web server(s) 102 may maintain, or otherwise designate, one or more application server(s) 114 to respond to requests received from client device(s) 106. In at least one embodiment, application server(s) 114 provide access to business logic for use by client application programs in client device(s) 106. Application server(s) 114 may be co-located, co-owned, or co-managed with web server(s) 102. Application server(s) 114 may also be remote from web server(s) 102. In at least one embodiment, application server(s) 114 interact with one or more analytical server(s) 116 and one or more data server(s) 118 to perform one or more operations of the disclosed technology.

One or more storage devices 153 may act as a “data store” by storing data pertinent to operation of system 100. This data may include, for example, and not by way of limitation, audio data 154 representing one or more audio signals. Audio data 154 may, for example, be extracted from audiovisual streams or stored audiovisual content representing sporting events and/or other events.

Audio data 154 can include any information related to audio embedded in the audiovisual stream, such as an audio stream that accompanies video imagery, processed versions of the audiovisual stream, and metrics and/or vectors related to audio data 154, such as time indices, durations, magnitudes, and/or other parameters of events. User data 155 can include any information describing one or more users 150, including for example, demographics, purchasing behavior, audiovisual stream viewing behavior, interests, preferences, and/or the like. Highlight data 164 may include highlights, highlight identifiers, time indicators, categories, excitement levels, and other data pertaining to highlights. Audio data 154, user data 155, and highlight data 164 will be described in detail subsequently.

Notably, many components of system 100 may be, or may include, computing devices. Such computing devices may each have an architecture similar to that of client device 106, as shown and described above. Thus, any of communications network 104, web servers 102, application servers 114, analytical servers 116, data providers 122, content providers 124, data servers 118, and storage devices 153 may include one or more computing devices, each of which may optionally have an input device 151, display screen 152, memory 156, and/or a processor 157, as described above in connection with client devices 106.

In an exemplary operation of system 100, one or more users 150 of client devices 106 view content from content providers 124, in the form of audiovisual streams. The audiovisual streams may show events, such as sporting events. The audiovisual streams may be digital audiovisual streams that can readily be processed with known computer vision techniques.

As the audiovisual streams are displayed, one or more components of system 100, such as client devices 106, web servers 102, application servers 114, and/or analytical servers 116, may analyze the audiovisual streams, identify highlights within the audiovisual streams, and/or extract metadata from the audiovisual stream, for example, from an audio component of the stream. This analysis may be carried out in response to receipt of a request to identify highlights and/or metadata for the audiovisual stream. Alternatively, in another embodiment, highlights and/or metadata may be identified without a specific request having been made by user 150. In yet another embodiment, the analysis of audiovisual streams can take place without an audiovisual stream being displayed.

In at least one embodiment, user 150 can specify, via input device(s) 151 at client device 106, certain parameters for analysis of audio data 154 (such as, for example, what event/games/teams to include, how much time user 150 has available to view the highlights, what metadata is desired, and/or any other parameters). User preferences can also be extracted from storage, such as from user data 155 stored in one or more storage devices 153, so as to customize analysis of audio data 154 without necessarily requiring user 150 to specify preferences. In at least one embodiment, user preferences can be determined based on observed behavior and actions of user 150, for example, by observing website visitation patterns, television watching patterns, music listening patterns, online purchases, previous highlight identification parameters, highlights and/or metadata actually viewed by user 150, and/or the like.

Additionally, or alternatively, user preferences can be retrieved from previously stored preferences that were explicitly provided by user 150. Such user preferences may indicate which teams, sports, players, and/or types of events are of interest to user 150, and/or they may indicate what type of metadata or other information related to highlights, would be of interest to user 150. Such preferences can therefore be used to guide analysis of the audiovisual stream to identify highlights and/or extract metadata for the highlights.

Analytical server(s) 116, which may include one or more computing devices as described above, may analyze live and/or recorded feeds of play-by-play statistics related to one or more events from data provider(s) 122. Examples of data provider(s) 122 may include, but are not limited to, providers of real-time sports information such as STATS™, Perform (available from Opta Sports of London, UK), and SportRadar of St. Gallen, Switzerland. In at least one embodiment, analytical server(s) 116 generate different sets of excitement levels for events; such excitement levels can then be stored in conjunction with highlights identified by or received by system 100 according to the techniques described herein.

Application server(s) 114 may analyze the audiovisual stream to identify the highlights and/or extract the metadata. Additionally, or alternatively, such analysis may be carried out by client device(s) 106. The identified highlights and/or extracted metadata may be specific to a user 150; in such case, it may be advantageous to identify the highlights in client device 106 pertaining to a particular user 150. Client device 106 may receive, retain, and/or retrieve the applicable user preferences for highlight identification and/or metadata extraction, as described above. Additionally, or alternatively, highlight generation and/or metadata extraction may be carried out globally (i.e., using objective criteria applicable to the user population in general, without regard to preferences for a particular user 150). In such a case, it may be advantageous to identify the highlights and/or extract the metadata in application server(s) 114.

Content that facilitates highlight identification, audio analysis, and/or metadata extraction may come from any suitable source, including from content provider(s) 124, which may include websites such as YouTube, MLB.com, and the like; sports data providers; television stations; client- or server-based DVRs; and/or the like. Alternatively, content can come from a local source such as a DVR or other recording device associated with (or built into) client device 106. In at least one embodiment, application server(s) 114 generate a customized highlight show, with highlights and metadata, available to user 150, either as a download, or streaming content, or on-demand content, or in some other manner.

As mentioned above, it may be advantageous for user-specific highlight identification, audio analysis, and/or metadata extraction to be carried out at a particular client device 106 associated with a particular user 150. Such an embodiment may avoid the need for video content or other high-bandwidth content to be transmitted via communications network 104 unnecessarily, particularly if such content is already available at client device 106.

For example, referring now to FIG. 1B, there is shown an example of a system 160 according to an embodiment wherein at least some of audio data 154 and highlight data 164 are stored at client-based storage device 158, which may be any form of local storage device available to client device 106. An example is a DVR on which events may be recorded, such as for example video content for a complete sporting event. Alternatively, client-based storage device 158 can be any magnetic, optical, or electronic storage device for data in digital form; examples include flash memory, magnetic hard drive, CD-ROM, DVD-ROM, or other device integrated with client device 106 or communicatively coupled with client device 106. Based on the information provided by application server(s) 114, client device 106 may extract highlights and/or metadata from video content (for example, including audio data 154) stored at client-based storage device 158 and store the highlights and/or metadata as highlight data 164 without having to retrieve other content from a content provider 124 or other remote source. Such an arrangement can save bandwidth, and can usefully leverage existing hardware that may already be available to client device 106.

Returning to FIG. 1A, in at least one embodiment, application server(s) 114 may identify different highlights and/or extract different metadata for different users 150, depending on individual user preferences and/or other parameters. The identified highlights and/or extracted metadata may be presented to user 150 via any suitable output device, such as display screen 152 at client device 106. If desired, multiple highlights may be identified and compiled into a highlight show, along with associated metadata. Such a highlight show may be accessed via a menu, and/or assembled into a “highlight reel,” or set of highlights, that plays for user 150 according to a predetermined sequence. User 150 can, in at least one embodiment, control highlight playback and/or delivery of the associated metadata via input device(s) 151, for example to:
select particular highlights and/or metadata for display;
pause, rewind, fast-forward;
skip forward to the next highlight;
return to the beginning of a previous highlight within the highlight show; and/or
perform other actions.

Additional details on such functionality are provided in the above-cited related U.S. patent applications.

In at least one embodiment, one or more data server(s) 118 are provided. Data server(s) 118 may respond to requests for data from any of server(s) 102, 114, 116, for example to obtain or provide audio data 154, user data 155, and/or highlight data 164. In at least one embodiment, such information can be stored at any suitable storage device 153 accessible by data server 118, and can come from any suitable source, such as from client device 106 itself, content provider(s) 124, data provider(s) 122, and/or the like.

Referring now to FIG. 1C, there is shown a system 180 according to an alternative embodiment wherein system 180 is implemented in a stand-alone environment. As with the embodiment shown in FIG. 1B, at least some of audio data 154, user data 155, and highlight data 164 may be stored at a client-based storage device 158, such as a DVR or the like. Alternatively, client-based storage device 158 can be flash memory or a hard drive, or other device integrated with client device 106 or communicatively coupled with client device 106.

User data 155 may include preferences and interests of user 150. Based on such user data 155, system 180 may extract highlights and/or metadata to present to user 150 in the manner described herein. Additionally, or alternatively, highlights and/or metadata may be extracted based on objective criteria that are not based on information specific to user 150.

Referring now to FIG. 1D, there is shown an overview of a system 190 with architecture according to an alternative embodiment. In FIG. 1D, system 190 includes a broadcast service such as content provider(s) 124, a content receiver in the form of client device 106 such as a television set with a STB, a video server such as analytical server(s) 116 capable of ingesting and streaming audiovisual content, such as television programming content, and/or other client devices 106 such as a mobile device and a laptop, which are capable of receiving and processing audiovisual content, such as television programming content, all connected via a network such as communications network 104. A client-based storage device 158, such as a DVR, may be connected to any of client devices 106 and/or other components, and may store an audiovisual stream, highlights, highlight identifiers, and/or metadata to facilitate identification and presentation of highlights and/or extracted metadata via any of client devices 106.

The specific hardware architectures depicted in FIGS. 1A, 1B, 1C, and 1D are merely exemplary. One skilled in the art will recognize that the techniques described herein can be implemented using other architectures. Many components depicted therein are optional and may be omitted, consolidated with other components, and/or replaced with other components.

In at least one embodiment, the system can be implemented as software written in any suitable computer programming language, whether in a standalone or client/server architecture. Alternatively, it may be implemented and/or embedded in hardware.

### Data Structures

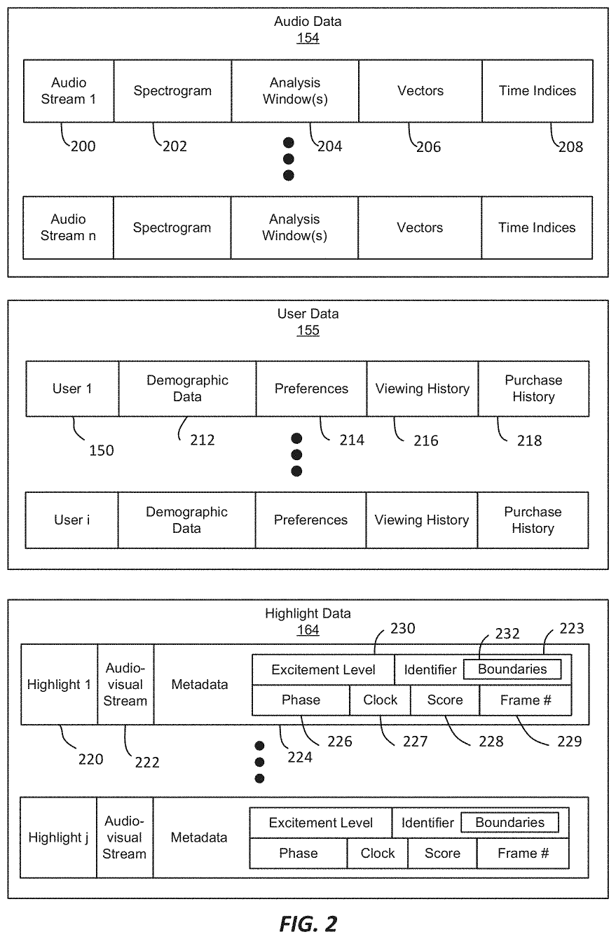

FIG. 2 is a schematic block diagram depicting examples of data structures that may be incorporated into audio data 154, user data 155, and highlight data 164, according to one embodiment.

As shown, audio data 154 may include a record for each of a plurality of audio streams 200. For illustrative purposes, audio streams 200 are depicted, although the techniques described herein can be applied to any type of audio data 154 or content, whether streamed or stored. The records of audio data 154 may include, in addition to the audio streams 200, other data produced pursuant to, or helpful for, analysis of the audio streams 200. For example, audio data 154 may include, for each audio stream 200, a spectrogram 202, one or more analysis windows 204, vectors 206, and time indices 208.

Each audio stream 200 may reside in the time domain. Each spectrogram 202 may be computed for the corresponding audio stream 200 in the time-frequency domain. Spectrogram 202 may be analyzed to more easily locate soft-entry points.

Analysis windows 204 may be designations of predetermined time and/or frequency intervals of the spectrograms 202. Computationally, a single moving (i.e., “sliding”) analysis window 204 may be used to analyze a spectrogram 202, or a series of displaced (optionally overlapping) analysis windows 204 may be used.

Vectors 206 may be data sets containing interim and/or final results from analysis of audio stream 200 and/or corresponding spectrogram 202.

Time indices 208 may indicate times, within audio stream 200 (and/or the audiovisual stream from which audio stream 200 is extracted) at which key events occur. For example, time indices 208 may be the times, within audiovisual content, at which the soft-entry points begin, are centered, or end. Thus, time indices 208 may indicate the beginnings or ends of particularly interesting parts of the audiovisual stream, such as, in the context of a sporting event, important or impressive plays.

As further shown, user data 155 may include records pertaining to users 150, each of which may include demographic data 212, preferences 214, viewing history 216, and purchase history 218 for a particular user 150.

Demographic data 212 may include any type of demographic data, including but not limited to age, gender, location, nationality, religious affiliation, education level, and/or the like.

Preferences 214 may include selections made by user 150 regarding his or her preferences. Preferences 214 may relate directly to highlight and metadata gathering and/or viewing, or may be more general in nature. In either case, preferences 214 may be used to facilitate identification and/or presentation of the highlights and metadata to user 150.

Viewing history 216 may list television programs, audiovisual streams, highlights, web pages, search queries, sporting events, and/or other content retrieved and/or viewed by user 150.

Purchase history 218 may list products or services purchased or requested by user 150.

As further shown, highlight data 164 may include records for j highlights 220, each of which may include an audiovisual stream 222 and/or metadata 224 for a particular highlight 220.

Audiovisual stream 222 may include audio and/or video depicting highlight 220, which may be obtained from one or more audiovisual streams of one or more events (for example, by cropping the audiovisual stream to include only audiovisual stream 222 pertaining to highlight 220). Within metadata 224, identifier 223 may include time indices (such as time indices 208 of audio data 154) and/or other indicia that indicate where highlight 220 resides within the audiovisual stream of the event from which it is obtained.

In some embodiments, the record for each of highlights 220 may contain only one of audiovisual stream 222 and identifier 223. Highlight playback may be carried out by playing audiovisual stream 222 for user 150, or by using identifier 223 to play only the highlighted portion of the audiovisual stream for the event from which highlight 220 is obtained. Storage of identifier 223 is optional; in some embodiments, identifier 223 may only be used to extract audiovisual stream 222 for highlight 220, which may then be stored in place of identifier 223. In either case, time indices 208 for highlight 220 may be extracted from audio data 154 and stored, at least temporarily, as metadata 224 that is either appended to highlight 220, or to the audiovisual stream from which audio data 154 and highlight 220 are obtained. In some embodiments, time indices 208 may be stored as boundaries 232 of identifier 223.

In addition to or in the alternative to identifier 223, metadata 224 may include information about highlight 220, such as the event date, season, and groups or individuals involved in the event or the audiovisual stream from which highlight 220 was obtained, such as teams, players, coaches, anchors, broadcasters, and fans, and/or the like. Among other information, metadata 224 for each highlight 220 may include a phase 226, clock 227, score 228, a frame number 229, and/or an excitement level 230.

Phase 226 may be the phase of the event pertaining to highlight 220. More particularly, phase 226 may be the stage of a sporting event in which the start, middle, and/or end of highlight 220 resides. For example, phase 226 may be “third quarter,” “second inning,” “bottom half,” or the like.

Clock 227 may be the game clock pertaining to highlight 220. More particularly, clock 227 may be the state of the game clock at the start, middle, and/or end of highlight 220. For example, clock 227 may be “15:47” for a highlight 220 that begins, ends, or straddles the period of a sporting event at which fifteen minutes and forty-seven seconds are displayed on the game clock.

Score 228 may be the game score pertaining to highlight 220. More particularly, score 228 may be the score at the beginning, end, and/or middle of highlight 220. For example, score 228 may be “45-38,” “7-0,” “30-love,” or the like.

Frame number 229 may be the number of the video frame, within the audiovisual stream from which highlight 220 is obtained, or audiovisual stream 222 pertaining to highlight 220, that relates to the start, middle, and/or end of highlight 220.

Excitement level 230 may be a measure of how exciting or interesting an event or highlight is expected to be for a particular user 150, or for users in general. In at least one embodiment, excitement level 230 may be computed as indicated in the above-referenced related applications. Additionally, or alternatively, excitement level 230 may be determined, at least in part, by analysis of audio data 154, which may be a component that is extracted from audiovisual stream 222 and/or audio stream 200. For example, audio data 154 that contains higher levels of crowd noise, announcements, and/or up-tempo music may be indicative of a high excitement level 230 for associated highlight 220. Excitement level 230 need not be static for a highlight 220, but may instead change over the course of highlight 220. Thus, system 100 may be able to further refine highlights 220 to show a user only portions that are above a threshold excitement level 230.

The data structures set forth in FIG. 2 are merely exemplary. Those of skill in the art will recognize that some of the data of FIG. 2 may be omitted or replaced with other data in the performance of highlight identification and/or metadata extraction. Additionally, or alternatively, data not specifically shown in FIG. 2 or described in this application may be used in the performance of highlight identification and/or metadata extraction.

### Analysis of Audio Data

In at least one embodiment, the system performs several stages of analysis of audio data 154, such as an audio stream, in the time-frequency domain, so as to detect soft-entry points, such as pauses or low points in speech, music, or other sound, during a depiction of a sporting event or another event. The depiction may be a television broadcast, audiovisual stream, audio stream, stored file, and/or the like.

First, compressed audio data 154 is read, decoded, and resampled to a desired sampling rate. Next, the resulting PCM stream is pre-filtered for noise reduction, click removal, and/or selection of desired frequency band, using any of a number of interchangeable digital filtering stages. Subsequently, a spectrogram is constructed for audio data 154. Spectral magnitude valleys are identified at each position of a sliding two-dimensional time-frequency area window. Further steps may be undertaken to more fully and/or reliably identify the soft-entry points 320.

Time indices 208 corresponding to the soft-entry points may be used as boundaries 232 (for example, beginnings or ends) of highlights 220. In some embodiments, these time indices 208 may be used to identify the actual beginning and/or ending points of highlights 220 that have already been identified (for example, with tentative boundaries 232 which may be tentative beginning and ending points that can subsequently be adjusted based on identification of soft-entry points). Highlights 220 may be extracted and/or identified, within the video stream, for subsequent viewing by the user.

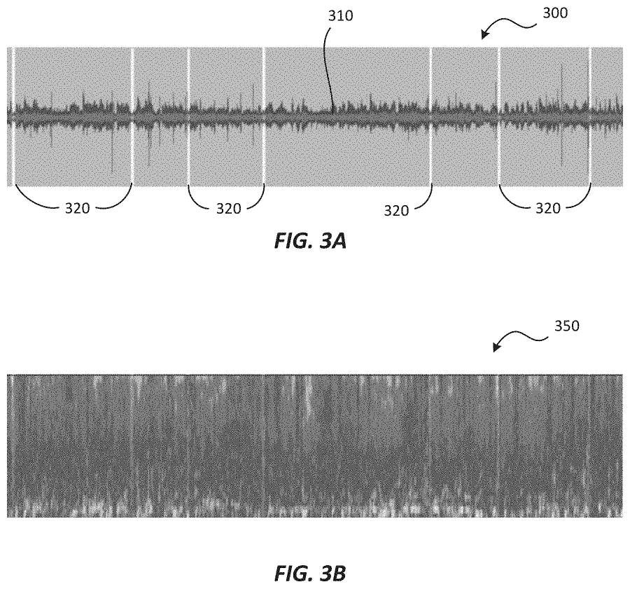

FIG. 3A depicts an example of an audio waveform graph 300 in an audio stream 310 extracted from sporting event television programming content in a time domain, according to one embodiment. Highlighted areas show exemplary soft-entry points 320, such as less intense portions of the audio stream 310. The amplitude of captured audio may be relatively low in the soft-entry points 320, representing relatively quiet portions of audio stream 310.

FIG. 3B depicts an example of a spectrogram 350 corresponding to audio waveform graph 300 of FIG. 3A, in a time-frequency domain, according to one embodiment. In at least one embodiment, detecting and marking of occurrences of events of interest is performed in the time-frequency domain, and boundaries 232 for the event (not shown in FIGS. 3A and 3B) are presented in real-time to the video highlights and metadata generation application. These boundaries 232 may be used to extract one or more highlights 220 from the video stream, or to determine, with greater accuracy, the beginning and/or ending of each highlight 220 within the video stream so that the highlight 220 can be played without inadvertently playing other content representing portions of the video stream that are not part of the highlight. Boundaries 232 may be used to reduce abruptness in transitions from one highlight 220 to another, by helping in determining appropriate transition points in the content, such as at the end of sentences or during pauses in the audio. In some embodiments, boundaries 232 may be incorporated into metadata 224, such as in the identifiers 223 that identify the beginning and/or end of a highlight 220, as set forth in the description of FIG. 2.

### Audio Data Analysis and Metadata Extraction

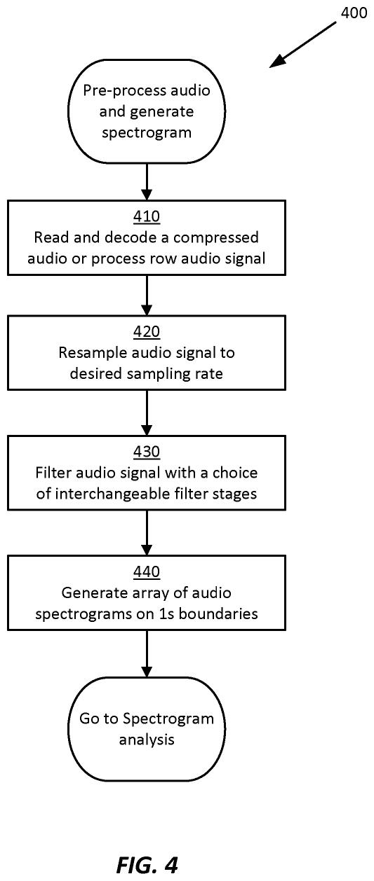

FIG. 4 is a flowchart depicting a method 400 for audio preprocessing by resampling, filtering and spectrogram construction, according to one embodiment. In at least one embodiment, method 400 may be carried out by an application (for example, running on one of client devices 106 and/or analytical servers 116) that receives an audiovisual stream and performs on-the-fly processing of audio data 154 for identification of soft-entry points 320, for example, corresponding to boundaries 232 of highlights 220, according to one embodiment. According to method 400, audio data 154 such as audio stream 310 may be processed to detect soft-entry points 320 in audio data 154 by detecting pauses, breaks, or other natural dividers between segments of audio, video, and/or audiovisual programming content.

In at least one embodiment, method 400 (and/or other methods described herein) is performed on audio data 154 that has been extracted from audiovisual stream or other audiovisual content. Alternatively, the techniques described herein can be applied to other types of source content. For example, audio data 154 need not be extracted from an audiovisual stream; rather it may be a radio broadcast or other audio depiction of a sporting event or other event.

In at least one embodiment, method 400 (and/or other methods described herein) may be performed by a system such as system 100 of FIG. 1A; however, alternative systems, including but not limited to system 160 of FIG. 1B, system 180 of FIG. 1C, and system 190 of FIG. 1D, may be used in place of system 100 of FIG. 1A. Further, the following description assumes that less intense audio events are to be identified; however, it will be understood that different types of audible events may be identified and used to extract metadata and/or identify boundaries 232 of highlights 220 according to methods similar to those explicitly described herein. In some embodiments, particular audio and/or visual cues (such as tones, dark screens, or the like) may be identified as soft-entry points.

Method 400 of FIG. 4 may commence with a step 410 in which audio data 154, such as an audio stream 200, is read; if audio data 154 is in a compressed format, it can optionally be decoded. In a step 420, audio data 154 may be resampled to a desired sampling rate. In a step 430, audio data 154 may be filtered using any of a number of interchangeable digital filtering stages. Next, in a step 440, a spectrogram 202 may be generated for the filtered audio data 154, for example by computing a Short-time Fourier Transform (STFT) on one-second chunks of the filtered audio data 154. Time-frequency coefficients for spectrogram 202 may be saved in a two-dimensional array for further processing.

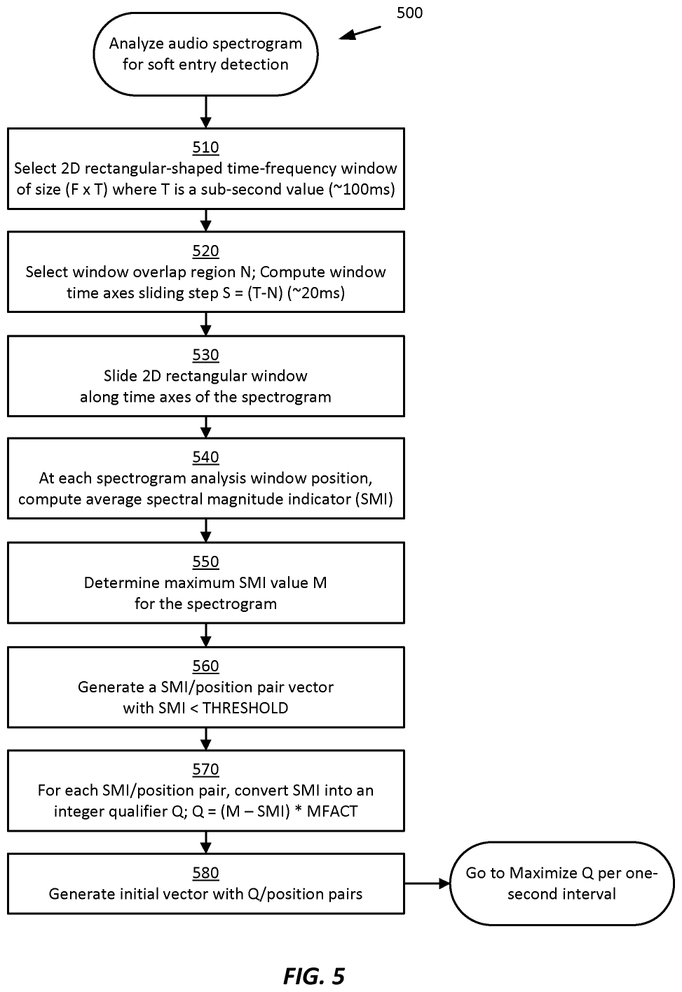

In some embodiments, when only relatively silent areas in the audio stream are of interest, irrespective of spectral content, step 440 may be omitted, and further analysis may be simplified via performance on time-domain audio data 154 only. However, in such a case, undesirable soft-entry detections may occur due to inherently unreliable indicators based on thresholding of audio volume only, without consideration of spectral content pertinent to particular sounds of interest such as a commentator's voice and/or background audience noise, which may be of low volume in the time-domain but may have rich spectral content in the time-frequency domain. In some embodiments, analysis of the audio stream can also be carried out in both the time-domain and time-frequency domain, with subsequent consolidation of detected soft-entry points into a final result. In further descriptions, in FIGS. 5 through 10 below, it is assumed that step 440 has been carried out, and that the audio analysis steps are performed on spectrogram 202 corresponding to audio data 154 (for example, after decoding, resampling, and/or filtering audio data 154 as described above). The final vector of soft-entry points in the audio stream may be formed with a focus on, but not limited to, detection of low volume and low spectral content of segments of an audio stream pertinent to gaps in commentator's speech such as the end of words, group of words, and sentences.

FIG. 5 is a flowchart depicting a method 500 for analyzing audio data 154, such as audio stream 200, in the time-frequency domain, for example, by analyzing spectrogram 202 to generate an initial vector of selected qualifier/position pairs, according to one embodiment. First, in a step 510, a two-dimensional rectangular-shaped time-frequency analysis window 204 of size (F×T) is selected, where T is a multi-second value (typically ˜100 ms), and F is frequency range to be considered (typically 100 Hz to 3 kHz). Next, in a step 520, a window overlap region N is selected between adjacent analysis windows 204, and window sliding step S=(T−N) is computed (typically ˜20 msec).

The method proceeds to a step 530 in which analysis window 204 slides along the spectral time axis in successive steps S along time axes of the spectrogram 202. In a step 540, at each position of analysis window 204, an average spectral magnitude indicator (SMI) is computed. In a step 550, a maximum SMI value M for the spectrogram may also be determined. In a step 560, an SMI/position pair vector, with SMI below a threshold, may be generated.

In a step 570, each SMI may be converted into an integer qualifier Q according to the equation Q=(M−SMI)*MFACT, where MFACT is a factor used to extract a desired number of integer digits. In a step 580, an initial vector of Q/position pairs may be generated as a superset of potential soft-entry points 320. The method 500 may then proceed to maximization of the qualifier for each one-second interval.

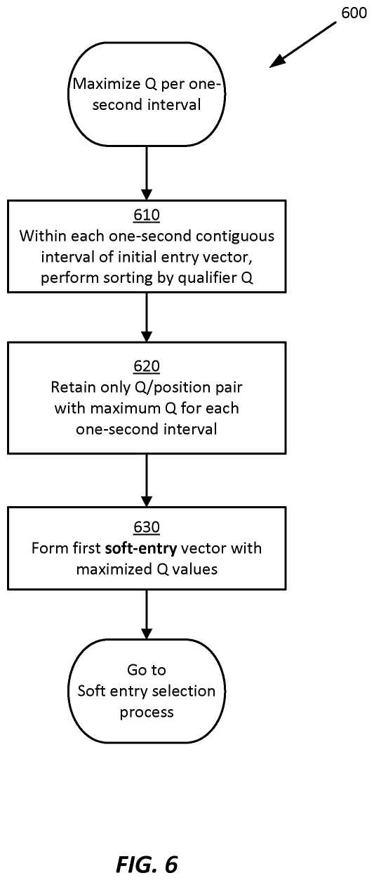

FIG. 6 is a flowchart depicting a method 600 for generating a vector with maximized qualifiers within each one-second interval, according to one embodiment. This may include a step 610, in which the initial vector with Q/position elements is partitioned on one-second boundaries. Within each one-second contiguous interval, sorting by qualifier Q may be performed. In a step 620, only Q/position pairs with maximum Q for each one-second interval may be retained. In a step 630, a first soft-entry vector with maximized Q values may be formed.

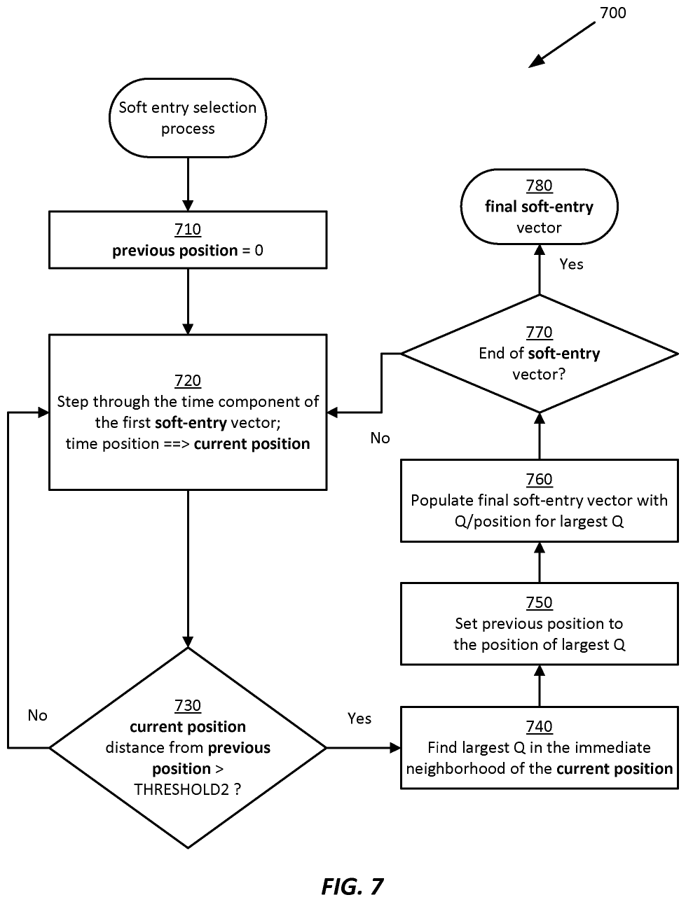

FIG. 7 is a flowchart depicting a method 700 for further selection of soft-entry points 320 with variable spacing and maximized local neighborhood qualifier, according to one embodiment. Such processing may lead to generation of extended variable-size intervals (mutual distances) for soft entries (typically averaging 2-3 seconds), and simultaneous maximization of the spectral qualifier at a local neighborhood of each interval.

As shown, the method 700 may start 710 in which the anchor point (previous position) is set to zero. Then, in a step 720, the method 700 may step through the time component of the first soft-entry vector to detect a next time position and load it into the current position. At each step, a query 730 may be carried out, in which the time distance from the current position to the previous position is checked against a threshold. If this distance is greater than the threshold (such as two seconds, for example), the current position may be taken for further processing in a step 740. If this distance is not greater than the threshold, the step 720 may be repeated for a new time position.

The step 740 may include testing the immediate neighborhood of the retained current position, and identifying an element with largest Q. In a step 750, this element may be loaded into the previous position, which now becomes the new anchor point for further testing. In a step 760, the final soft-entry vector may also be populated with this locally maximized Q/position pair.

The method 700 may proceed in successive steps until all elements of the first soft-entry vector are exhausted. Specifically, a query 770 may ascertain whether the end of the soft-entry vector has been reached. If so, the final soft-entry vector may be provided in a step 780. If not, the method 700 may return to the step 720 for further iteration.

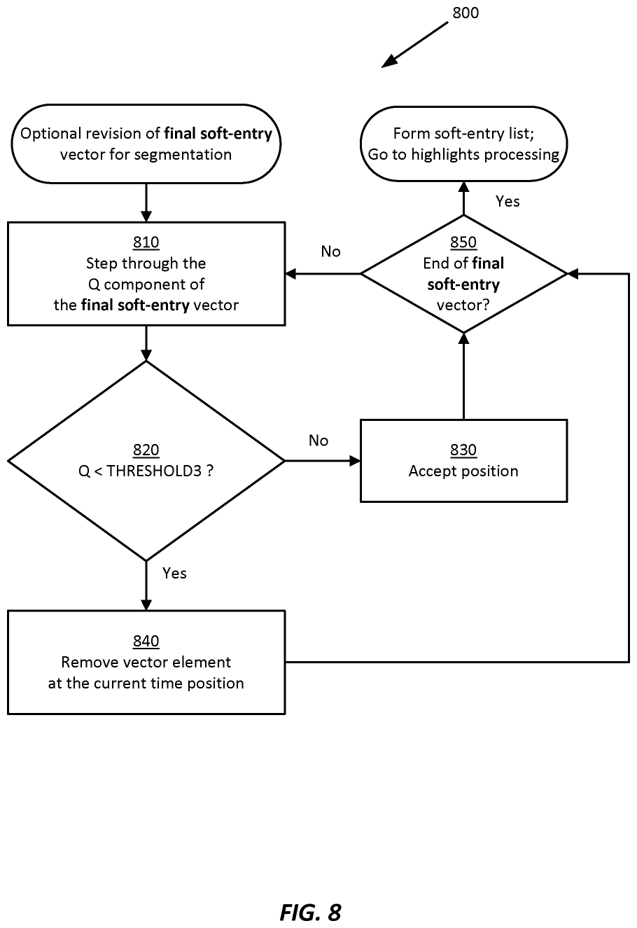

FIG. 8 is a flowchart depicting a method 800 for optional revision of detected entry points for sparse segmentation, according to one embodiment. The method 800 may be used to further maximize the Q qualifier for cases in which there are less stringent requirements on boundaries of highlighted events. The method 800 may begin with a step 810, in which the method 800 steps through the soft-entry vector elements one at a time. In a query 820, the method 800 may test the Q value against a threshold. In a step 840, the Q/position pairs below the threshold may be removed. In a step 830, the Q/position pairs above the threshold may be retained.

The method 800 may proceed in successive steps until all elements of the final soft-entry vector are exhausted. Specifically, a query 850 may ascertain whether the end of the final soft-entry vector has been reached. If so, the method 800 may proceed to formation of a list of soft-entry points 320 and highlight processing. If not, the method 800 may return to the step 810 for further iteration.

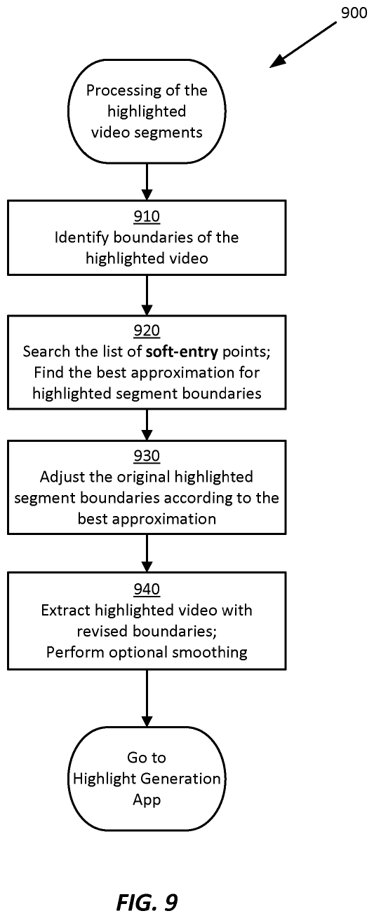

FIG. 9 is a flowchart depicting a method 900 for assembling adjusted highlights 220 based on a list of available soft-entry points, according to one embodiment. First, in a step 910, tentative boundaries 232 of the highlight 220 may be identified. Next, in a step 920, a search of the list of soft-entry points 320 may be performed, and the best approximation for one or more tentative boundaries 232 of highlight 220 may be generated. Next, in a step 930, tentative boundaries 232 may be adjusted according to the best approximation obtained from the list. In a step 940, highlight 220 with revised boundaries may be extracted, and optionally processed by deploying a fading function with mirrored lead and trail curvatures, allowing for further smoothing of audio transitions between disjoint segments (such as multiple highlights 220 to be played continuously, as in a highlight reel).

The present system and method have been described in particular detail with respect to possible embodiments. Those of skill in the art will appreciate that the system and method may be practiced in other embodiments. First, the particular naming of the components, capitalization of terms, the attributes, data structures, or any other programming or structural aspect is not mandatory or significant, and the mechanisms and/or features may have different names, formats, or protocols. Further, the system may be implemented via a combination of hardware and software, or entirely in hardware elements, or entirely in software elements. Also, the particular division of functionality between the various system components described herein is merely exemplary, and not mandatory; functions performed by a single system component may instead be performed by multiple components, and functions performed by multiple components may instead be performed by a single component.

Reference in the specification to “one embodiment”, or to “an embodiment”, means that a particular feature, structure, or characteristic described in connection with the embodiments is included in at least one embodiment. The appearances of the phrases “in one embodiment” or “in at least one embodiment” in various places in the specification are not necessarily all referring to the same embodiment.

Various embodiments may include any number of systems and/or methods for performing the above-described techniques, either singly or in any combination. Another embodiment includes a computer program product comprising a non-transitory computer-readable storage medium and computer program code, encoded on the medium, for causing a processor in a computing device or other electronic device to perform the above-described techniques.

Some portions of the above are presented in terms of algorithms and symbolic representations of operations on data bits within the memory of a computing device. These algorithmic descriptions and representations are the means used by those skilled in the data processing arts to most effectively convey the substance of their work to others skilled in the art. An algorithm is here, and generally, conceived to be a self-consistent sequence of steps (instructions) leading to a desired result. The steps are those requiring physical manipulations of physical quantities. Usually, though not necessarily, these quantities take the form of electrical, magnetic or optical signals capable of being stored, transferred, combined, compared and otherwise manipulated. It is convenient at times, principally for reasons of common usage, to refer to these signals as bits, values, elements, symbols, characters, terms, numbers, or the like. Furthermore, it is also convenient at times, to refer to certain arrangements of steps requiring physical manipulations of physical quantities as modules or code devices, without loss of generality.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “displaying” or “determining” or the like, refer to the action and processes of a computer system, or similar electronic computing module and/or device, that manipulates and transforms data represented as physical (electronic) quantities within the computer system memories or registers or other such information storage, transmission or display devices.

Certain aspects include process steps and instructions described herein in the form of an algorithm. It should be noted that the process steps and instructions can be embodied in software, firmware and/or hardware, and when embodied in software, can be downloaded to reside on and be operated from different platforms used by a variety of operating systems.

The present document also relates to an apparatus for performing the operations herein. This apparatus may be specially constructed for the required purposes, or it may comprise a general-purpose computing device selectively activated or reconfigured by a computer program stored in the computing device. Such a computer program may be stored in a computer readable storage medium, such as, but not limited to, any type of disk including floppy disks, optical disks, CD-ROMs, DVD-ROMs, magnetic-optical disks, read-only memories (ROMs), random access memories (RAMs), EPROMs, EEPROMs, flash memory, solid state drives, magnetic or optical cards, application specific integrated circuits (ASICs), or any type of media suitable for storing electronic instructions, and each coupled to a computer system bus. The program and its associated data may also be hosted and run remotely, for example on a server. Further, the computing devices referred to herein may include a single processor or may be architectures employing multiple processor designs for increased computing capability.

The algorithms and displays presented herein are not inherently related to any particular computing device, virtualized system, or other apparatus. Various general-purpose systems may also be used with programs in accordance with the teachings herein, or it may be more convenient to construct specialized apparatus to perform the required method steps. The required structure for a variety of these systems will be apparent from the description provided herein. In addition, the system and method are not described with reference to any particular programming language. It will be appreciated that a variety of programming languages may be used to implement the teachings described herein, and any references above to specific languages are provided for disclosure of enablement and best mode.

Accordingly, various embodiments include software, hardware, and/or other elements for controlling a computer system, computing device, or other electronic device, or any combination or plurality thereof. Such an electronic device can include, for example, a processor, an input device (such as a keyboard, mouse, touchpad, track pad, joystick, trackball, microphone, and/or any combination thereof), an output device (such as a screen, speaker, and/or the like), memory, long-term storage (such as magnetic storage, optical storage, and/or the like), and/or network connectivity, according to techniques that are well known in the art. Such an electronic device may be portable or non-portable. Examples of electronic devices that may be used for implementing the described system and method include: a desktop computer, laptop computer, television, smartphone, tablet, music player, audio device, kiosk, set-top box, game system, wearable device, consumer electronic device, server computer, and/or the like. An electronic device may use any operating system such as, for example and without limitation: Linux; Microsoft Windows, available from Microsoft Corporation of Redmond, Wash.; Mac OS X, available from Apple Inc. of Cupertino, Calif.; iOS, available from Apple Inc. of Cupertino, Calif.; Android, available from Google, Inc. of Mountain View, Calif.; and/or any other operating system that is adapted for use on the device.

While a limited number of embodiments have been described herein, those skilled in the art, having benefit of the above description, will appreciate that other embodiments may be devised. In addition, it should be noted that the language used in the specification has been principally selected for readability and instructional purposes, and may not have been selected to delineate or circumscribe the subject matter. Accordingly, the disclosure is intended to be illustrative, but not limiting, of scope.

What is claimed is:

1. A method for identifying a boundary of a highlight of audiovisual content depicting an event, the method comprising:
at a data store, storing audio data depicting at least part of the event;
at a processor, automatically analyzing the audio data to detect a soft-entry point of the audio data; and
at the processor, designating a time index, within the audiovisual content, corresponding to the soft-entry point as the boundary, the boundary comprising one of a beginning of the highlight and an end of the highlight.

2. The method of claim 1, wherein the audiovisual content comprises a television broadcast.

3. The method of claim 1, wherein the audiovisual content comprises an audiovisual stream, and wherein the method further comprises, prior to storing audio data depicting at least part of the event, extracting the audio data from the audiovisual stream.

4. The method of claim 1, wherein the audiovisual content comprises stored audiovisual content, and wherein the method further comprises, prior to storing audio data depicting at least part of the event, extracting the audio data from the stored audiovisual content.

5. The method of claim 1, wherein:
the event comprises a sporting event; and
the highlight depicts a portion of the sporting event deemed to be of particular interest to at least one user.

6. The method of claim 5, further comprising, at an output device, playing at least one of the audiovisual content and the highlight during detection of the soft-entry point.

7. The method of claim 1, further comprising, prior to detecting the soft-entry point, pre-processing the audio data by resampling the audio data to a desired sampling rate.

8. The method of claim 1, further comprising, prior to detecting the soft-entry point, pre-processing the audio data by filtering the audio data to perform at least one of:
reducing noise; and
selecting a spectral band of interest.

9. The method of claim 1, further comprising, prior to detecting the soft-entry point, processing the audio data to generate a spectrogram for at least part of the audio data.

10. The method of claim 9, wherein detecting the soft-entry point comprises applying a sliding two-dimensional time-frequency analysis window of sub-second time extent for the spectrogram.

11. The method of claim 10, wherein detecting the soft-entry point comprises:
computing an average spectral magnitude indicator for each position of the sliding two-dimensional time-frequency analysis window; and
using the average spectral magnitude indicators to form a vector of spectral magnitude indicator/position pairs for the spectrogram.

12. The method of claim 11, wherein detecting the soft-entry point further comprises:
for each element of the vector with spectral magnitude indicator/position pairs, converting the spectral magnitude indicator into an integer qualifier Q; and
generating an initial vector with Q/position pairs for the spectrogram.

13. The method of claim 12, wherein detecting the soft-entry point further comprises:
partitioning the initial vector with Q/position pairs into contiguous one-second intervals; and
maximizing Q per one-second interval.

14. The method of claim 13, wherein maximizing Q per one-second interval comprises:
sorting qualifiers Q for each one-second interval; and
performing non-maximum suppression in each one-second interval to form a first vector of Q/position pairs for the spectrogram.

15. The method of claim 14, wherein detecting the soft-entry point further comprises:
stepping through a time position of elements of the first vector of Q/position pairs;
for each time position, comparing time of a current position with time of a previous position to obtain a time distance;
for each element of the first vector of Q/position pairs, for which the time distance is greater than a threshold, finding a largest Q in an immediate neighborhood of the current position; and
populating a new soft-entry vector with the Q/position pairs with the largest Q.

16. The method of claim 15, wherein finding the largest Q in the immediate neighborhood further comprises:
designating a first element of the first vector as an anchor element; and
selecting a next element displaced from the first element by about two seconds.

17. The method of claim 16, wherein finding the largest Q in the immediate neighborhood further comprises:
examining elements to either side of the next element; and
designating the element, of the next element and the elements to either side of the next element, with maximized qualifier Q as a new anchor element.

18. The method of claim 17, wherein finding the largest Q in the immediate neighborhood further comprises processing all elements of the first vector of Q/position pairs in successive steps to produce a set of soft-entry points with variable mutual distances, and with maximized spectral qualifier Q.

19. The method of claim 18, further comprising:
translating the set of soft-entry points into a list of best entry points; and
selecting the time index from the list of best entry points.

20. The method of claim 1, further comprising, prior to designating the time index as the boundary, identifying the highlight with a tentative boundary;
wherein:
the soft-entry point is the closest in time, of a plurality of soft-entry points in the audio data, to the tentative boundary; and
designating the time index as the boundary comprises replacing the tentative boundary with the boundary.

21. A non-transitory computer-readable medium for identifying a boundary of a highlight of audiovisual content depicting an event, comprising instructions stored thereon, that when executed by a processor, perform the steps of:
causing a data store to store audio data depicting at least part of the event;
automatically analyzing the audio data to detect a soft-entry point of the audio data; and
designating a time index, within the audiovisual content, corresponding to the soft-entry point as the boundary, the boundary comprising one of a beginning of the highlight and an end of the highlight.

22. The non-transitory computer-readable medium of claim 21, wherein the audiovisual content comprises a television broadcast.

23. The non-transitory computer-readable medium of claim 21, wherein:
the event comprises a sporting event; and
the highlight depicts a portion of the sporting event deemed to be of particular interest to at least one user.

24. The non-transitory computer-readable medium of claim 23, further comprising instructions stored thereon, that when executed by a processor, cause an output device to play at least one of the audiovisual content and the highlight during detection of the soft-entry point.

25. The non-transitory computer-readable medium of claim 21, further comprising instructions stored thereon, that when executed by a processor, preprocess the audio data, prior to detecting the soft-entry point, by performing at least one of:
resampling the audio data to a desired sampling rate;
filtering the audio data to reduce noise; and
filtering the audio data to select a spectral band of interest.

26. The non-transitory computer-readable medium of claim 21, further comprising instructions stored thereon, that when executed by a processor, preprocess the audio data, prior to detecting the soft-entry point, process the audio data to generate a spectrogram for at least part of the audio data.

27. The non-transitory computer-readable medium of claim 26, wherein detecting the soft-entry point comprises applying a sliding two-dimensional time-frequency analysis window of sub-second time extent for the spectrogram.

28. The non-transitory computer-readable medium of claim 27, wherein detecting the soft-entry point comprises:
computing an average spectral magnitude indicator for each position of the sliding two-dimensional time-frequency analysis window;
using the average spectral magnitude indicators to form a vector of spectral magnitude indicator/position pairs for the spectrogram;
for each element of the vector with spectral magnitude indicator/position pairs, converting the spectral magnitude indicator into an integer qualifier Q;
generating an initial vector with Q/position pairs for the spectrogram;
partitioning the initial vector with Q/position pairs into contiguous one-second intervals; and
maximizing Q per one-second interval;
wherein maximizing Q per one-second interval comprises:
sorting qualifiers Q for each one-second interval; and
performing non-maximum suppression in each one-second interval to form a first vector of Q/position pairs for the spectrogram.

29. The non-transitory computer-readable medium of claim 28, wherein detecting the soft-entry point further comprises:
stepping through a time position of elements of the first vector of Q/position pairs;
for each time position, comparing time of a current position with time of a previous position to obtain a time distance;
for each element of the first vector of Q/position pairs, for which the time distance is greater than a threshold, finding a largest Q in an immediate neighborhood of the current position; and
populating a new soft-entry vector with the Q/position pairs with the largest Q;
wherein finding the largest Q in the immediate neighborhood further comprises:
designating a first element of the first vector as an anchor element;
selecting a next element displaced from the first element by about two seconds;
examining elements to either side of the next element;
designating the element, of the next element and the elements to either side of the next element, with maximized qualifier Q as a new anchor element; and
processing all elements of the first vector of Q/position pairs in successive steps to produce a set of soft-entry points with variable mutual distances, and with maximized spectral qualifier Q;
wherein the non-transitory computer-readable medium further comprises instructions stored thereon, that when executed by a processor:
translate the set of soft-entry points into a list of best entry points; and
select the time index from the list of best entry points.

30. The non-transitory computer-readable medium of claim 21, further comprising instructions stored thereon, that when executed by a processor identify the highlight with a tentative boundary, prior to designating the time index as the boundary;
wherein:
the soft-entry point is the closest in time, of a plurality of soft-entry points in the audio data, to the tentative boundary; and
designating the time index as the boundary comprises replacing the tentative boundary with the boundary.

31. A system for identifying a boundary of a highlight of audiovisual content depicting an event, the system comprising:
a data store configured to store audio data depicting at least part of the event; and
a processor configured to:
automatically analyze the audio data to detect a soft-entry point of the audio data; and
designate a time index, within the audiovisual content, corresponding to the soft-entry point as the boundary, the boundary comprising one of a beginning of the highlight and an end of the highlight.

32. The system of claim 31, wherein the audiovisual content comprises a television broadcast.

33. The system of claim 31, wherein:
the event comprises a sporting event; and
the highlight depicts a portion of the sporting event deemed to be of particular interest to at least one user.

34. The system of claim 33, further comprising an output device configured to play at least one of the audiovisual content and the highlight during detection of the soft-entry point.

35. The system of claim 31, wherein the processor is further configured, prior to detecting the soft-entry point, pre-process the audio data to perform at least one of:
resampling the audio data to a desired sampling rate;
filtering the audio data to reduce noise; and
filtering the audio data to select a spectral band of interest.

36. The system of claim 31, wherein the processor is further configured to, prior to detecting the soft-entry point, process the audio data to generate a spectrogram, for at least part of the audio data.

37. The system of claim 36, wherein the processor is further configured to detect the soft-entry point by applying a sliding two-dimensional time-frequency analysis window of sub-second time extent for the spectrogram.

38. The system of claim 37, wherein the processor is further configured to detect the soft-entry point by:
computing an average spectral magnitude indicator for each position of the sliding two-dimensional time-frequency analysis window;
using the average spectral magnitude indicators to form a vector of spectral magnitude indicator/position pairs for the spectrogram;
for each element of the vector with spectral magnitude indicator/position pairs, converting the spectral magnitude indicator into an integer qualifier Q;
generating an initial vector with Q/position pairs for the spectrogram;
partitioning the initial vector with Q/position pairs into contiguous one-second intervals; and
maximizing Q per one-second interval;
wherein the processor is further configured to maximize Q per one-second interval by:
sorting qualifiers Q for each one-second interval; and
performing non-maximum suppression in each one-second interval to form a first vector of Q/position pairs for the spectrogram.

39. The system of claim 38, wherein the processor is further configured to detect the soft-entry point further by:
stepping through a time position of elements of the first vector of Q/position pairs;
for each time position, comparing time of a current position with time of a previous position to obtain a time distance;
for each element of the first vector of Q/position pairs, for which the time distance is greater than a threshold, finding a largest Q in an immediate neighborhood of the current position; and
populating a new soft-entry vector with the Q/position pairs with the largest Q;
wherein the processor is further configured to find the largest Q in the immediate neighborhood by:
designating a first element of the first vector as an anchor element;
selecting a next element displaced from the first element by about two seconds;
examining elements to either side of the next element;
designating the element, of the next element and the elements to either side of the next element, with maximized qualifier Q as a new anchor element;
processing all elements of the first vector of Q/position pairs in successive steps to produce a set of soft-entry points with variable mutual distances, and with maximized spectral qualifier Q;
wherein the processor is further configured to:
translate the set of soft-entry points into a list of best entry points; and
select the time index from the list of best entry points.

40. The system of claim 31, wherein the processor is further configured to, prior to designating the time index as the boundary, identify the highlight with a tentative boundary;
wherein:
the soft-entry point is the closest in time, of a plurality of soft-entry points in the audio data, to the tentative boundary; and
designating the time index as the boundary comprises replacing the tentative boundary with the boundary.
